(19) United States
(12) Patent Application Publication
(10) Pub. No.: US 2025/0253805 A1
(43) Pub. Date: Aug. 7, 2025

(54) PHOTOVOLTAIC SYSTEM

(71) Applicant: Anker Innovations Technology Co., Ltd., Changsha (CN)

(72) Inventors: Wei Chen, Shenzhen (CN); Yiyong Li, Shenzhen (CN); Fei Luo, Shenzhen (CN)

(21) Appl. No.: 19/036,315

(22) Filed: Jan. 24, 2025

(30) Foreign Application Priority Data
Feb. 5, 2024 (CN) 202410166883.7

(51) Int. Cl. H02S 40/32; H02S 50/10

(52) U.S. Cl. CPC H02S 40/32; H02S 50/10

(57) ABSTRACT

Disclosed are a photovoltaic system and a method for operating the photovoltaic system. A load device and a switching device are connected in series at an output end of the photovoltaic panel. Upon receiving a power supply instruction to start power supply to the electrical equipment, the output power parameter and the output electrical parameter ratio of the photovoltaic panel are determined. A connection status between the photovoltaic panel and the micro-inverter may be adjusted based on the output power parameter and the output electrical parameter ratio. The photovoltaic system can determine whether to control the photovoltaic panel to access the micro-inverter for operation by analyzing the output of the photovoltaic panel and according to actual output conditions of the photovoltaic panel.

### CROSS-REFERENCE OF RELATED APPLICATION

The present application claims priority to CN 202410166883.7, filed on Feb. 5, 2024, which is incorporated by reference by its entirety.

### FIELD

The present disclosure relates to the technical field of photovoltaics, particularly to a photovoltaic system and a method for operating the photovoltaic system.

### BACKGROUND

With development of new energy technologies and proposal of energy conservation and emission reduction, photovoltaic power generation has been widely applied due to its advantages such as being clean and pollution-free, having a short construction period, a long service life, and low maintenance cost. In photovoltaic power generation technology, photovoltaic panels typically get access to an AC grid via micro photovoltaic grid-tied inverters to supply power to the AC grid.

However, in related art, specifications of the photovoltaic panels are not known for micro photovoltaic grid-tied inverters, resulting in poor access reliability of the photovoltaic panels.

### SUMMARY

This application describes a photovoltaic system and methods for operating the photovoltaic system to address an issue of poor access reliability of a photovoltaic panel.

A method for operating a photovoltaic system comprising: determining, by a controller, an output power parameter and an output electrical parameter ratio associated with a photovoltaic panel, wherein the photovoltaic panel is connected to a load and a micro-inverter, and the load is connected to a switching device; and adjusting a connection status between the photovoltaic panel and the micro-inverter based on the output power parameter and the output electrical parameter ratio.

A photovoltaic system comprising a load; a micro-inverter connected to an electrical equipment; a photovoltaic panel connected to the load and the micro-inverter; a switching device connected to the load; and a controller connected to the switching device, wherein the controller is configured to: determine an output power parameter and an output electrical parameter ratio associated with the photovoltaic panel; and adjusting a connection status between the photovoltaic panel and the micro-inverter based on the output power parameter and the output electrical parameter ratio.

In the photovoltaic system, a load device and a switching device may be connected in series at the output end of the photovoltaic panel. Upon receiving a power supply instruction to start power supply to the electrical equipment, the output power parameter and the output electrical parameter ratio of the photovoltaic panel are determined firstly. Subsequently, the connection status between the photovoltaic panel and the micro-inverter may be adjusted based on the output power parameter and the output electrical parameter ratio (e.g., the photovoltaic system may determine whether the micro-inverter gets access to the photovoltaic panel based on the output power parameter and the output electrical parameter ratio). The photovoltaic system can determine whether to control the photovoltaic panel to access the micro-inverter for operation by analyzing the output of the photovoltaic panel and according to actual output conditions of the photovoltaic panel. Thus, even without knowing specifications of the photovoltaic panel or whether the photovoltaic panel is in daytime or nighttime, access control between the micro-inverter and the photovoltaic panel can still be achieved precisely, thereby effectively improving the access reliability of the photovoltaic panel.

### BRIEF DESCRIPTION OF THE DRAWINGS

In order to more clearly illustrate the disclosure or the technical solutions, drawings that need to be used in description of the examples are briefly introduced below. It will be apparent to those of ordinary skill in the art that the drawings in the following description only show some examples of the disclosure, and other drawings can be obtained from these drawings without inventive work.

FIG. 1 is a schematic structural diagram of a photovoltaic system in an example of the present disclosure;

FIG. 2 is a schematic flow diagram of a method for operating the photovoltaic system in an example of the present disclosure;

FIG. 3 is a schematic flow diagram of analysis of an output power parameter and an output electrical parameter ratio in an example of the present disclosure;

FIG. 4 is a schematic flow diagram of analysis of a first power parameter, a second power parameter, and an output electrical parameter ratio in an example of the present disclosure;

FIG. 5 is a schematic flow diagram of a method for operating the photovoltaic system in another example of the present disclosure;

FIG. 6 is a schematic flow diagram of threshold determination in an example of the present disclosure;

FIG. 7 is a schematic flow diagram of analysis of an output power parameter and an output electrical parameter ratio in another example of the present disclosure; and

FIG. 8 is a schematic structural diagram of a photovoltaic system in another example of the present disclosure.

### DETAILED DESCRIPTION

In order to facilitate understanding of the present disclosure, the present disclosure will be described comprehensively below with reference to the accompanying drawings. The present disclosure may be implemented in many different forms and is not limited to the examples described herein. These examples are provided to understand contents of the disclosure thoroughly and comprehensively.

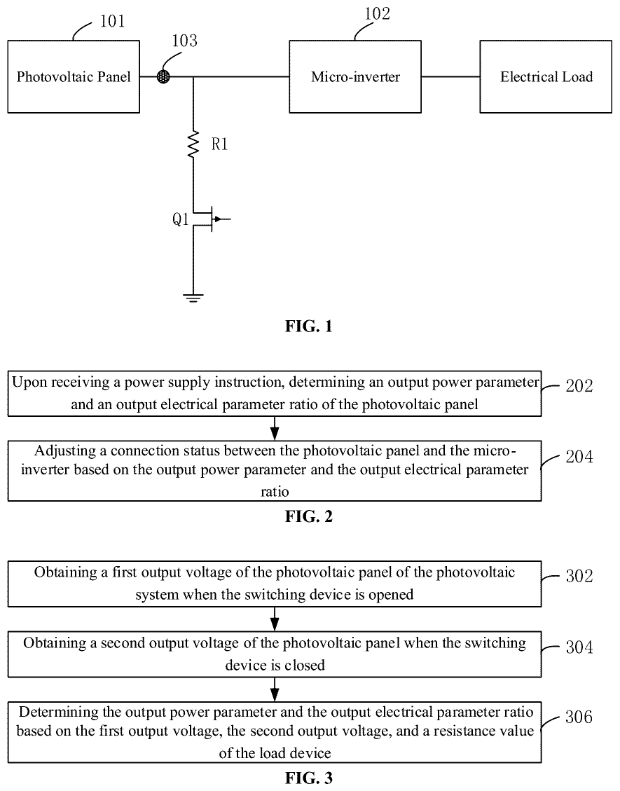

A method for operating a photovoltaic system provided in the examples of the present disclosure can be applied in a photovoltaic system, which can specifically refer to FIG. 1. The photovoltaic system includes a photovoltaic panel 101 and a micro-inverter 102. The micro-inverter 102 may be a plug-and-play device that converts direct current (DC) generated by a single solar module to alternating current (AC). An output end of the photovoltaic panel 101 is connected to the micro-inverter 102 which is connected to an electrical equipment (e.g., one or more household load devices). DC power generated by the photovoltaic panel 101 through photoelectric effect is converted by the micro-inverter 102 and supplied to the electrical equipment in a form of AC power. Furthermore, in an example, a voltage collector 103 is provided at the output end of the photovoltaic panel 101. In some examples, the micro-inverter 102 may act as a voltage collector and dynamically adjusts its operation to harvest the maximum power point (MPP) of the panel using MPPT (Maximum Power Point Tracking) technology. In other examples, the voltage collector may be a charge controller, a voltage regulator, or an electronic load or sensor. Additionally, a load device (e.g., a load) R1 and a switching device Q1 are sequentially connected to the output end of the photovoltaic panel 101. When the switching device Q1 is open, the load device R1 is not accessed (e.g., connected) to the photovoltaic panel 101, in which case a voltage is not divided between the photovoltaic panel 101 and the load device R1. When the switching device Q1 is closed, the voltage is divided between the photovoltaic panel 101 and the load device R1, causing a certain change in a voltage value at the output end of the photovoltaic panel 101.

A controller of the photovoltaic system is connected to the switching device Q1 and the voltage collector 103, respectively. Through the controller, not only can an on-off status of the switching device Q1 be controlled, but an output of the photovoltaic panel 101 can also be respectively obtained via the voltage collector 103 in a case of the switching device Q1 being either on or off, and thus realizing the method for operating the photovoltaic system described herein.

The present disclosure provides a method for operating a photovoltaic system. The photovoltaic system includes a photovoltaic panel, a switching device, a load device, and a micro-inverter. An output end of the photovoltaic panel is connected to a first end of the load device, a second end of the load device is connected to a first end of the switching device, and a second end of the switching device is grounded. Referring to FIG. 2, the method includes step 202 and step 204.
Step 202: upon receiving a power supply instruction, an output power parameter and an output electrical parameter ratio of the photovoltaic panel are determined (e.g., measured).

Specifically, the switching device includes a device capable of performing a switching function under control of a controller or manual operation by a user. The photovoltaic panel includes a photoelectric conversion device capable of converting solar or light energy into electric energy. The load device includes a device capable of functioning as a load to consume the electric energy. The output power parameter includes a parameter related to an output power of the photovoltaic panel, which can specifically be an output power value or variation in output power at different output statuses of the photovoltaic panel, which is not specifically limited herein. The output electrical parameter ratio includes a ratio of electrical parameters collected (e.g., measured) at the output end of the photovoltaic panel at different output statuses. Specifically, there may be two or more different output statuses of the photovoltaic panel, which can be two statuses of the photovoltaic panel being accessed by the load device and not being accessed by the load device. The output electrical parameter ratio may specifically be a ratio of output voltages.

It can be understood that specific types of the load device and the switching device are not limited and can be selected in connection with actual needs. For example, the load device can be a resistor, which may specifically be a single resistor or a resistor assembly formed by multiple resistors connected in series and/or parallel. In another example, the load device can be an energy-consuming device, such as an indicator light. The switching device can be a power switching tube (e.g., a triode or a field-effect transistor) or a relay.

The output end of the photovoltaic panel is coupled to the micro-inverter, and is configured to supply power to the electrical equipment through the micro-inverter. Additionally, the switching device and the load device are connected in series at the output end of the photovoltaic panel. In this way, during an operation of the photovoltaic panel, the switching devices are controlled to be opened and connected so that the photovoltaic panel is in different output statuses.

The method described herein involves detecting the output of the photovoltaic panel, so that after the photovoltaic panel gets access to the micro-inverter, it can supply suitable electric energy to the electrical equipment, thereby maintaining a stable operation of the electrical equipment. As a result, the controller needs to monitor operational requirements of the photovoltaic system, and upon detecting a received power supply instruction (e.g., when the photovoltaic panel needs to charge or supply power to the electrical equipment), it is considered that the photovoltaic system has an output detection need. At this point, a process of obtaining the output power parameter and the output electrical parameter ratio may be initiated.
Step 204: a connection status between the photovoltaic panel and the micro-inverter is adjusted based on the output power parameter and the output electrical parameter ratio.

The connection status between the photovoltaic panel and the micro-inverter includes at least two statuses: the micro-inverter being connected to the photovoltaic panel, and the micro-inverter being disconnected from the photovoltaic panel. After the output power parameter and the output electrical parameter ratio are determined, the controller is configured to determine whether the micro-inverter can be accessed to the photovoltaic panel based on the output power parameter and the output electrical parameter ratio and according to actual values of the output power parameter and the output electrical parameter ratio.

In the method for operating the photovoltaic system, the load device and the switching device are connected in series at the output end of the photovoltaic panel. Upon receiving the power supply instruction to initiate power supply to the electrical equipment, the output power parameter and the output electrical parameter ratio of the photovoltaic panel are determined. Then, the connection status between the photovoltaic panel and the micro-inverter may be adjusted based on the output power parameter and the output electrical parameter ratio. For example, a controller can be configured to determine whether the micro-inverter gets access to the photovoltaic panel based on the output power parameter and the output electrical parameter ratio. The controller can be configured to determine whether to control the photovoltaic panel to access the micro-inverter for operation by analyzing the output of the photovoltaic panel based on actual output conditions of the photovoltaic panel. In this way, even without knowing the specifications of the photovoltaic panel or whether the photovoltaic panel is in daytime or nighttime, connection control between the micro-inverter and the photovoltaic panel can still be achieved precisely, thereby effectively improving the access reliability of the photovoltaic panel.

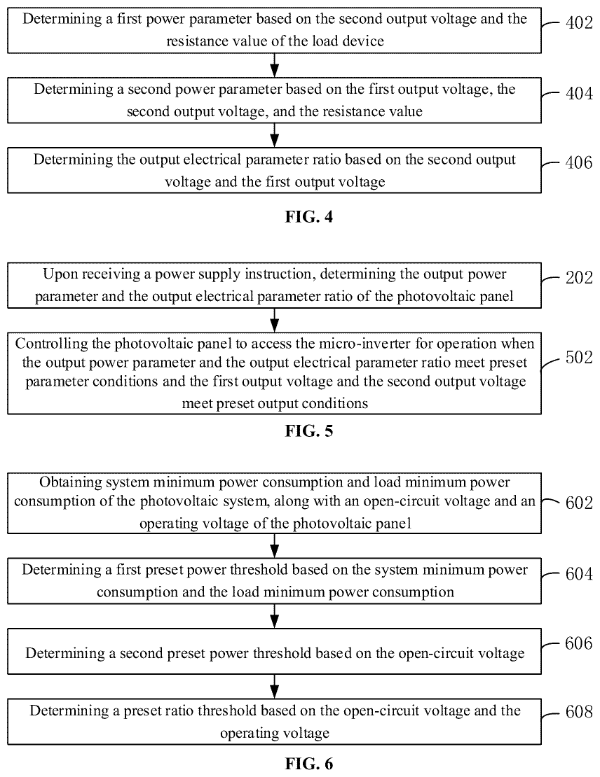

Referring to FIG. 3, in an example, the determination of the output power parameter and the output electrical parameter ratio of the photovoltaic panel may include steps 302, 304, and 306.
Step 302: a first output voltage of the photovoltaic panel of the photovoltaic system is obtained in a case of (e.g., when) the switching device being opened.
Step 304: a second output voltage of the photovoltaic panel is obtained in a case of (e.g., when) the switching device being closed.
Step 306: the output power parameter and the output electrical parameter ratio are determined based on the first output voltage, the second output voltage, and a resistance value of the load device.

Specifically, the resistance value of the load device includes an equivalent resistance value of the load device, which may specifically vary depending on a type of load device. This resistance value can be stored in the controller in a preset form. The output end of the photovoltaic panel may get access to the micro-inverter, and supply power to the electrical equipment through the micro-inverter. Additionally, the switching device and the load device are connected in series at the output end of the photovoltaic panel. During the operation of the photovoltaic panel, the first output voltage of the photovoltaic panel can be obtained at the output end by controlling the switching device to be opened.

It should be noted that a method of opening the switching device is not limited, and a corresponding operation may differ depending on the type of switching device. In an example, taking the switching device as a power switching tube or a relay as an example, the switching device is also connected to the controller, and when the controller detects a need to detect the output of the photovoltaic panel, the controller controls an on-off status of the switching device. In another example, the switching device can also be a manual switch, and when the need to detect the output of the photovoltaic panel is detected, a user can manually control the on-off status of the switching device, which is not limited herein.

A method for obtaining the first output voltage is not limited herein. In an example, a voltage collector can be provided at the output end of the photovoltaic panel, which is connected to the controller through wired or wireless communication. When the switching device is opened, the voltage collector can be configured to obtain the first output voltage and transmit it to the controller. In another example, the controller may be integrated with a voltage collection function and is directly connected to the output end of the photovoltaic panel to perform a voltage collection operation at the output end of the photovoltaic panel.

As described above, the switching device and the load device are provided at the output end of the photovoltaic panel. After the first output voltage is obtained by manually opening the switching device or having the controller to control the switching device to be opened, the switching device can be closed either manually by the user or automatically by the controller. In a case of the switching device being closed, the second output voltage of the photovoltaic panel can be obtained through the voltage collector or directly collected by the controller.

After the first output voltage and the second output voltage are obtained, the controller retrieves the resistance value of the load device. By analyzing and calculating the first output voltage, the second output voltage and the resistance value, the output power parameter and the output electrical parameter ratio can be determined.

The first and second output voltages of the photovoltaic panel are obtained based on the on-off status of the switching device and the output power parameter and the output electrical parameter ratio are calculated based on the first output voltage, the second output voltage and the resistance value of the load device, which ensures high calculation accuracy.

Referring to FIG. 4, in an example, step 306 may include step 402, step 404, and step 406.
Step 402: a first power parameter is determined based on the second output voltage and the resistance value of the load device.
Step 404: a second power parameter is determined based on the first output voltage, the second output voltage, and the resistance value.
Step 406: the output electrical parameter ratio is determined based on the second output voltage and the first output voltage (e.g., a ratio of the second output voltage to the first output voltage).

Specifically, after the first output voltage and the second output voltage are collected and obtained in a case of the switching device being opened and closed, respectively, the controller may analyze the first output voltage and the second output voltage to determine the first power parameter, the second power parameter, and the output electrical parameter ratio required for detecting the output of the photovoltaic panel.

The output power parameter includes a parameter obtained by analyzing the first output voltage and/or the second output voltage, which characterizes an output power of the photovoltaic panel. The output electrical parameter ratio includes a parameter that characterizes variation in the first output voltage and the second output voltage.

Further, the first power parameter is determined based on the second output voltage and the resistance value of the load device, and is configured to characterize power generated by the output of the photovoltaic panel after the load device is accessed. The second power parameter is determined by analyzing voltage difference between the first output voltage and the second output voltage, and the resistance value, and is configured to characterize power variation caused by accessing of the load device.

During the operation of the photovoltaic panel, the output end of the photovoltaic panel may be voltage-divided by the load device with the on-off status of the switching device, causing corresponding changes in the power at the output end of the photovoltaic panel. Therefore, it may need to combine the first output voltage, the second output voltage, and the resistance value of the load device to determine the output power parameter, ensuring that the output power parameter can reasonably characterize an output condition of the photovoltaic panel.

Specifically, a power parameter (e.g., the first power parameter) of the photovoltaic system in an operation state of the load device in a case of the switching device being on, can be calculated based on the second output voltage and the resistance value of the load device. The power variation of the photovoltaic system (e.g., the second power parameter) in a case of the switching device being on relative to a case of the switching device being off can be calculated based on the first output voltage, the second output voltage, and the resistance value of the load device.

In the above scheme, the first power parameter, the second power parameter, and the output electrical parameter ratio are considered to detect the output of the photovoltaic panel, effectively improving accuracy of determining access of the photovoltaic panel.

Referring to FIG. 5, in an example, step 204 may include step 502.
Step 502: the photovoltaic panel is controlled to access the micro-inverter for operation in a case where the output power parameter and the output electrical parameter ratio meet preset parameter conditions, and the first output voltage and the second output voltage meet preset output conditions.

Specifically, the preset parameter conditions includes predefined conditions that the output power parameter and the output electrical parameter ratio need to meet when the photovoltaic panel gets access to the micro-inverter to supply power to the electrical equipment. The preset output conditions refer to predefined conditions that the first output voltage and the second output voltage need to meet when the photovoltaic panel gets access to the micro-inverter to supply power to the electrical equipment.

The controller is pre-stored with the preset parameter conditions and the preset output conditions. After the first output voltage and the second output voltage are analyzed to determine the output power parameter and the output electrical parameter ratio, the controller may determine whether the output power parameter and the output electrical parameter ratio meet the preset parameter conditions. Furthermore, after the first output voltage and the second output voltage are obtained, the controller may further determine whether the first output voltage and the second output voltage meet the preset output conditions. Finally, when the output power parameter and the output electrical parameter ratio meet the preset parameter conditions and the first output voltage and the second output voltage meet the preset output conditions, the photovoltaic panel is controlled to be accessed to the micro-inverter, and supply power to the electrical equipment through the micro-inverter. When the output power parameter and the output electrical parameter ratio do not meet the preset parameter conditions and/or the first output voltage and the second output voltage do not meet the preset output conditions, the controller may not control the photovoltaic panel to be accessed to the micro-inverter for operation.

With the above scheme, the first output voltage, the second output voltage, and the resistance value of the load device are taken to determine the output power parameter and the output electrical parameter ratio. The photovoltaic panel is controlled to be accessed to the micro-inverter for operation only when the output power parameter and the output electrical parameter ratio and the first and second output voltages meet certain conditions respectively, which exhibits high accuracy in access control.

It should be noted that in an example, an operation of the controller to determine whether the first output voltage and the second output voltage meet the preset output conditions can be performed after the controller determines whether the output power parameter and the output electrical parameter ratio meet the preset parameter conditions. In this case, the determination may be performed only if the controller determines that the output power parameter and the output electrical parameter ratio meet the preset parameter conditions; otherwise, there is no need to determine whether the first and second output voltages meet the preset output conditions.

In another example, the operation can also be performed before the controller determines whether the output power parameter and the output electrical parameter ratio meet the preset parameter conditions. Correspondingly, in this case, it is needed for the controller to determine whether the first output voltage and the second output voltage meet the preset output conditions, and only if the first output voltage and the second output voltage meet the preset output conditions, the controller may proceed to determine whether the output power parameter and the output electrical parameter ratio meet the preset parameter conditions; otherwise, there is no need to determine whether the output power parameter and the output electrical parameter ratio meet the preset parameter conditions.

Furthermore, in other examples, the operation can also be performed before the controller determines the output power parameter and the output electrical parameter ratio based on the first output voltage and the second output voltage. Correspondingly, in this case, it is needed for the controller to determine whether the first output voltage and the second output voltage meet the preset output conditions, and only if the first output voltage and the second output voltage meet the preset output conditions, the controller may proceed to determine the output power parameter and the output electrical parameter ratio; otherwise, there is no need to determine the output power parameter and the output electrical parameter ratio.

It should be noted that a calculation method for the first power parameter and the second power parameter is not limited. In a more detailed example, a calculation method for the first power parameter is expressed as: b\hat{ }2/R1=f, where f represents the first power parameter, b represents the second output voltage, and R1 represents the resistance value of the load device. Specifically, the first power parameter is obtained by dividing a square of the second output voltage by the resistance value.

A calculation method for the second power parameter is expressed as: (a−b)\hat{ }2/R1=g, where g represents the second power parameter, a represents the first output voltage, b represents the second output voltage, and R1 represents the resistance value of the load device. Specifically, the second power parameter is obtained by dividing a square of voltage difference between the first output voltage and the second output voltage by the resistance value.

In an example, a calculation method for the output electrical parameter ratio is expressed as: b/a=h, where h represents the output electrical parameter ratio, a represents the first output voltage, and b represents the second output voltage. Specifically, a ratio of the second output voltage to the first output voltage is taken as the output electrical parameter ratio.

In an example, the output power parameter and the output electrical parameter ratio meeting the preset parameter conditions includes: the first power parameter meeting a first parameter condition, the second power parameter meeting a second parameter condition, and the output electrical parameter ratio meeting a third parameter condition.

Specifically, corresponding to the output power parameter including the first power parameter and the second power parameter, the controller sets a respective parameter condition for each parameter. In determining whether the output power parameter and the output electrical parameter ratio meet the preset parameter conditions, it is necessary to sequentially determine whether the first power parameter meets the first parameter condition, the second power parameter meets the second parameter condition, and the output electrical parameter ratio meets the third parameter condition. Finally, if all of three parameters meet their respective parameter conditions simultaneously, it is considered that the output power parameter and the output electrical parameter ratio meet the preset parameter conditions; otherwise, it is considered that the output power parameter and the output electrical parameter ratio do not meet the preset parameter conditions.

In this scheme, it is determined whether the output power parameter and the output electrical parameter ratio meet the preset parameter conditions by individually determining whether the first power parameter meets the first parameter condition, the second power parameter meets the second parameter condition, and the output electrical parameter ratio meets the third parameter condition, which ensures high determination accuracy.

In an example, the method includes at least one of following: determining whether the first power parameter meets the first parameter condition (e.g., whether the first power parameter is greater than or equal to a first preset power threshold); determining whether the second power parameter meets the second parameter condition (e.g., whether the second power parameter is less than or equal to a second preset power threshold); and determining whether the output electrical parameter ratio meets the third parameter condition (e.g., whether the output electrical parameter ratio is greater than or equal to a preset ratio threshold).

The first preset power threshold, the second preset power threshold, and the preset ratio threshold are set for the first power parameter, the second power parameter, and the output electrical parameter ratio, respectively. Therefore, in an actual operation, it can be determined whether the first power parameter meets the first parameter condition by determining whether the first power parameter is greater than or equal to the first preset power threshold. Additionally or alternatively, it can be determined whether the second power parameter meets the second parameter condition by determining whether the second power parameter is less than or equal to the second preset power threshold. Additionally or alternatively, it can be further determined whether the output electrical parameter ratio meets the third parameter condition by determining whether the output electrical parameter ratio is greater than or equal to the preset ratio threshold.

In an example, upon obtaining the first power parameter, the second power parameter, and the output electrical parameter ratio, the controller performs compares and analyzes the first power parameter with the first preset power threshold, the second power parameter with the second preset power threshold, and the output electrical parameter ratio with the preset ratio threshold, which enables analysis and determination on whether the output power parameter and the output electrical parameter ratio meet the preset parameter conditions.

Different thresholds may be set for the first power parameter, the second power parameter, and the output electrical parameter ratio, respectively, and it is determined whether the parameter conditions are met by comparing each parameter with its corresponding threshold, which offers advantages of a simple determination method and high determination efficiency, effectively improving operational efficiency of the photovoltaic panel.

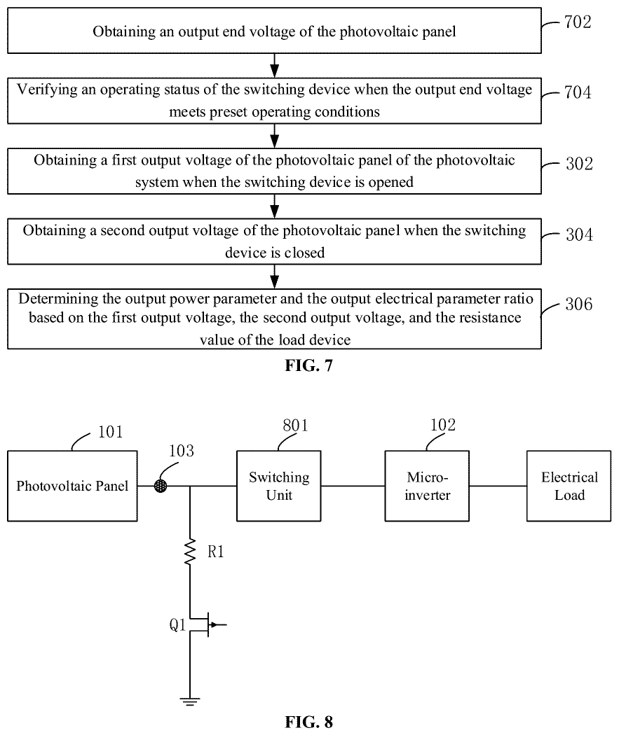

Referring to FIG. 6, in an example, before step 204, the method may further include steps 602, 604, 606, and 608.
Step 602: system minimum power consumption and load minimum power consumption of the photovoltaic system, along with an open-circuit voltage and an operating voltage of the photovoltaic panel, are obtained.
Step 604: the first preset power threshold is determined based on the system minimum power consumption and the load minimum power consumption.
Step 606: the second preset power threshold is determined based on the open-circuit voltage.
Step 608: the preset ratio threshold is determined based on the open-circuit voltage and the operating voltage.

Specifically, steps 602 to 608 can be performed between steps 202 and 204 or before step 202, which is not specifically limited. It should be noted that, in a more detailed example, since the system minimum power consumption and the load minimum power consumption of the photovoltaic system, along with the open-circuit voltage and the operating voltage of the photovoltaic panel, may remain essentially constant when the photovoltaic system is accessed and the electrical equipment is fixed, steps 602 to 608 can be performed during first execution of the method described in the present disclosure and then the determined first preset power threshold, second preset power threshold, and preset ratio threshold are stored in the controller, which can be directly retrieved during subsequent executions of the method. Accordingly, if the electrical equipment or the photovoltaic panel in the photovoltaic system changes, steps 602 to 608 must be re-performed to update the first preset power threshold, second preset power threshold, and preset ratio threshold.

When the controller has a need for monitoring of the output of the photovoltaic panel, it retrieves the system minimum power consumption and the load minimum power consumption of the photovoltaic system, along with the open-circuit voltage and the operating voltage of the photovoltaic panel. The first preset power threshold is determined by analyzing the system minimum power consumption and the load minimum power consumption, the second preset power threshold is determined based on the open-circuit voltage, and the preset ratio threshold is determined based on both the open-circuit voltage and the operating voltage.

In more detail, in an example, the first preset power threshold is calculated as a sum of the system minimum power consumption, load minimum power consumption, and a fixed power value. The fixed power value is not limited to a specific number and can be set as 10 W, 20 W, 30 W, or other values depending on actual needs, which is not specifically limited.

The second preset power threshold, determined based on the open-circuit voltage, can be calculated as: (k−k*0.5)\hat{ }2/R1, where * represents multiplication, \hat{ } represents square, k represents the open-circuit voltage, and R1 represents the resistance value of the load device. Specifically, the second preset power threshold is obtained by dividing a square of (k−k*0.5) by the resistance value.

The preset ratio threshold is related to the open-circuit voltage and the operating voltage, which can be obtained by multiplying the open-circuit voltage and the operating voltage by a corresponding ratio. The ratio can be set depending on specific requirements. For instance, the ratio can be 0.7, 0.8, 0.9, or the like, which is specifically not limited.

In the above scheme, the first preset power threshold, the second preset power threshold, and the preset ratio threshold are determined based on the system minimum power consumption, the load minimum power consumption, the open-circuit voltage, and the operating voltage. By integrating the analysis and determination of the output power parameter and the output electrical parameter ratio with an actual state of the photovoltaic system, accuracy of the preset parameter conditions is ensured.

In an example, the first output voltage and the second output voltage meeting the preset output conditions includes both the first output voltage and the second output voltage fall within a preset input voltage range.

Specifically, the preset input voltage range refers to a predefined range of an input voltage required for a normal operation of the electrical equipment accessed to the photovoltaic system. In this example, after the first output voltage and the second output voltage are obtained, the controller compares and analyzes the first output voltage and the second output voltage with the preset input voltage range. If both the first output voltage and the second output voltage are within the preset input voltage range, it is considered that they meet the preset output conditions.

It should be noted that the preset input voltage range is not unique. In actual scenarios, the preset input voltage range varies depending on a type of the electrical equipment accessed to the micro-inverter and can be set according to the actual scenarios. For example, in a more detailed example, the preset input voltage range can be set to 80V to 100V.

In this method, when both the first output voltage and the second output voltage fall within the preset input voltage range, it is considered that the preset output conditions are met, ensuring that the output voltage of the photovoltaic panel meets power requirements of the electrical equipment.

Referring to FIG. 7, in an example, before step 302, the method may further include steps 702 and 704.
Step 702: an output end voltage of the photovoltaic panel is obtained.
Step 704: an operating status of the switching device is verified in a case where the output end voltage meets the preset operating conditions.

Specifically, in a case where a need for output monitoring of the photovoltaic panel is detected by a power supply instruction, the output end voltage of the photovoltaic panel is first obtained for analysis. In a case where the output end voltage meets the preset operating conditions (e.g., the output end voltage is greater than or equal to a preset operating voltage threshold), the controller further detects the operating status of the switching device, and finally obtains the first output voltage and the second output voltage respectively based on the operating status of the switching device, enabling a determination of whether the photovoltaic panel should be accessed.

In the above scheme, the controller performs analysis and determination of whether the photovoltaic panel should be accessed after the power supply instruction is received, ensuring that the photovoltaic panel supplies power while matching a state of the electrical equipment, thereby improving the reliability of the photovoltaic panel's power supply.

In an example, a step in which the photovoltaic panel is controlled to be accessed to the micro-inverter for operation includes controlling the switching unit, which is connected to both the photovoltaic panel and the micro-inverter, to turn on.

Specifically, the micro-inverter is configured to be connected with the electrical equipment. In this example, the switching unit is further provided between the photovoltaic panel and the micro-inverter. The switching unit is connected to the controller, which controls the photovoltaic panel to be accessed to the micro-inverter or to be disconnected from the micro-inverter by controlling the switching unit to turn on or off. In a case where the photovoltaic panel gets access to the micro-inverter, the electric energy can be output to the electrical equipment through the micro inverter, and in a case where the photovoltaic panel is not accessed to the micro-inverter, the electrical equipment remains unpowered and stops operating.

It should be noted that a specific type of switching unit is not limited. Selection of the corresponding switching unit may vary depending on a model of the photovoltaic panel. For example, in an example, a DC converter may be used as the switching unit, and connection between the photovoltaic panel and the micro-inverter is controlled by starting or stopping the DC converter. In another example, a power switch or a relay may also be used as the switching unit, which can be selected according to the actual scenario and is not limited herein.

In the above methods, access control between the photovoltaic panel and the micro-inverter can be realized by controlling the switching unit provided between the photovoltaic panel and the micro-inverter, effectively improving the reliability of the access control for the photovoltaic panel.

To facilitate understanding of the technical features of the present disclosure, illustration is made in the following in combination with detailed embodiments.

Firstly, upon receiving the power supply instruction, the controller detects whether the output voltage of the photovoltaic panel meets the preset operating condition, (e.g., whether the output end voltage is greater than the preset operating voltage threshold). If the preset operating condition is met, the controller can be configured to detect the status of the switching device. If the switching device is opened, the first output voltage a of the photovoltaic panel is obtained. Then, the controller can control the switching device to be closed and the second output voltage b of the photovoltaic panel is obtained.

Afterwards, the controller can be configured to calculate the first power parameter f, the second power parameter g, and the output electrical parameter ratio h based on the first output voltage a, the second output voltage b, and the resistance value R1 of the load device (which may be a resistor), in a form as: b\hat{ }2/R1=f; (a−b)\hat{ }2/R1=g; b/a=h.

Then, it is determined whether f is greater than or equal to the first preset power threshold (which may be the sum of the system minimum power consumption, the load minimum power consumption and a fixed power value); whether g is less than or equal to the second preset power threshold, where the second preset power threshold can be (k−k*0.5)\hat{ }2/R1; whether the output electrical parameter ratio is greater than or equal to the preset ratio threshold (obtained by multiplying the open-circuit voltage and the operating voltage by the corresponding ratio, such as 0.8); and whether the first output voltage a and the second output voltage b both fall within the preset input voltage range. If all of the above determinations are true, it is considered that the output power parameter and the output electrical parameter ratio meet the preset parameter conditions, and that the first output voltage and second output voltage meet the preset output conditions. At this point, the controller may control the switching unit to conduct or turn on, allowing the electrical energy output by the photovoltaic panel to be transmitted to the electrical equipment through the switching unit and the micro-inverter.

It should be understood that, although various steps in the flowcharts involved in the examples described above are illustrated in an order indicated by the arrows, these steps are not necessarily performed in the order indicated by the arrows. Unless explicitly stated herein, there is no strict sequential restriction on execution of these steps, and they may be performed in other orders. Furthermore, at least some of the steps in the flowcharts involved in the examples described above may include multiple steps or multiple stages, and these steps or stages are not necessarily completed at the same time but may be executed at different times. The execution order of these steps or stages is also not necessarily sequential but may be performed alternatively or alternately with at least part of other steps, or at least part of steps or stages in the other steps.

Referring to FIG. 1, the present disclosure further provides a photovoltaic system, which includes: the load device R1, the micro-inverter 102, the photovoltaic panel 101, the voltage collector 103, the switching device Q1, and a controller (not shown). The micro-inverter 102 is configured to be connected to the electrical equipment. An output end of the photovoltaic panel 101 is connected to a first end of the load device R1 and the micro-inverter 102. The voltage collector 103 is provided at the output end of the photovoltaic panel 101. A first end of the switching device Q1 is connected to a second end of the load device R1, and a second end of the switching device Q1 is grounded. The controller is connected to the voltage collector 103 and the third end of the switching device Q1 to implement the steps of the method described above.

Specifically, implementation of the method is shown in the above examples and will not be repeated here. In the photovoltaic system, the load device R1 and the switching device Q1 may be connected in series at the output end of the photovoltaic panel 101. Upon receiving the power supply instruction to supply power to the electrical equipment, an output power parameter and an output electrical parameter ratio of the photovoltaic panel 101 are first determined. A connection status between the photovoltaic panel 101 and the micro-inverter 102 may be adjusted based on the output power parameter and the output electrical parameter ratio (e.g., the controller may determine whether the micro-inverter 102 gets access to the photovoltaic panel 101 based on the output power parameter and the output electrical parameter ratio). It can be determined whether to control the photovoltaic panel 101 to be accessed to the micro-inverter 102 for operation by analyzing an output of the photovoltaic panel 101 based on actual output conditions of the photovoltaic panel 101. Thus, even without knowing the specifications of the photovoltaic panel 101 and regardless of whether the photovoltaic panel 101 is in daytime or nighttime, connection control between the micro-inverter 102 and the photovoltaic panel 101 can be achieved, thereby effectively improving the access reliability of the photovoltaic panel 101.

In an example, the load device R1 comprises a resistor. Specifically, a specific type of load device R1 is not limited, as long as it can be used as a load to consume electrical energy. In this example, the load device R1 can be a resistor, which may specifically be a single resistor or a resistor assembly formed by multiple resistors connected in series and/or parallel. In another example, the load device R1 may be an energy-consuming device, such as an indicator light.

Similarly, the specific type of switching device Q1 is not limited. In an example, the switching device Q1 may be a power switching tube or a relay. The power switching tube may include a triode, a field-effect transistor, or an insulated-gate bipolar transistor, etc., which is not limited specifically.

Referring to FIG. 8, in an example, the photovoltaic system further includes a switching unit 801 (e.g., a switching device), and the output of the photovoltaic panel 101 is coupled to the micro-inverter 102 through the switching unit 801.

Specifically, in this example, the switching unit 801 may be further provided between the photovoltaic panel 101 and the micro-inverter 102. The switching unit 801 is connected to the controller, which controls the photovoltaic panel 101 to be accessed to the micro-inverter 102 or to be disconnected from the micro-inverter 102 by turning the switching unit 801 on or off. In a case where the photovoltaic panel 101 gets access to the micro-inverter 102, the electrical energy can be output to the electrical equipment through the micro-inverter 102, and in a case where the photovoltaic panel 101 is not accessed to the micro-inverter 102, the electrical equipment remains unpowered and stops operating.

It should be noted that a specific type of switching unite 801 is not limited. Selection of the corresponding switching unit 801 may vary depending on a model of the photovoltaic panel 101. For example, in an example, a DC converter may be used as the switching unit 801, where the connection between the photovoltaic panel 101 and the micro-inverter 102 is controlled by starting or stopping the DC converter. In another example, a power switch or a relay may also be used as the switching unit 801, which can be selected according to the actual scenarios and is not limited herein.

Various technical features of the above examples can be combined. To make the description concise, not all possible combinations of the technical features in the examples are described. However, as long as no contradiction occurs between the combinations of these technical features, the combinations should be considered within the scope of the description.

The examples described above represent only several examples of the present disclosure, which are described in detail but should not be construed as limitations of the scope of the disclosure. It should be noted that several variations and improvements can be made without departing from the spirit of the disclosure for those skilled in the art, all of which fall within the scope of the present disclosure. Accordingly, the scope of the present disclosure should be subject to the appended claims.

What is claimed is:

1. A method for operating a photovoltaic system, comprising:
determining, by a controller, an output power parameter and an output electrical parameter ratio associated with a photovoltaic panel, wherein the photovoltaic panel is connected to a load and a micro-inverter, and the load is connected to a switching device; and
adjusting a connection status between the photovoltaic panel and the micro-inverter based on the output power parameter and the output electrical parameter ratio.

2. The method according to claim 1, wherein the determining the output power parameter and the output electrical parameter ratio comprises:
obtaining a first output voltage of the photovoltaic panel when the switching device is open;
obtaining a second output voltage of the photovoltaic panel when the switching device is closed; and
determining the output power parameter and the output electrical parameter ratio based on the first output voltage, the second output voltage, and a resistance of the load.

3. The method according to claim 2, wherein the output power parameter comprises a first power parameter and a second power parameter, and the determining the output power parameter and the output electrical parameter ratio comprises:
determining the first power parameter based on the second output voltage and the resistance;
determining the second power parameter based on the first output voltage, the second output voltage, and the resistance; and
determining the output electrical parameter ratio based on a ratio of the second output voltage to the first output voltage.

4. The method according to claim 3, wherein the adjusting the connection status comprises:
controlling the photovoltaic panel to access the micro-inverter based on the output power parameter and the output electrical parameter ratio satisfying preset parameter conditions.

5. The method according to claim 4, wherein the output power parameter and the output electrical parameter ratio satisfying the preset parameter conditions comprises:
the first power parameter satisfying a first parameter condition, the second power parameter satisfying a second parameter condition, and the output electrical parameter ratio satisfying a third parameter condition.

6. The method according to claim 5, wherein the output power parameter and the output electrical parameter ratio satisfying the preset parameter conditions comprises at least one of:
the first power parameter being greater than or equal to a first threshold;
the second power parameter being less than or equal to a second threshold; and
the output electrical parameter ratio being greater than or equal to a ratio threshold.

7. The method according to claim 1, wherein before the adjusting the connection status, the method further comprises:
obtaining system minimum power consumption and load minimum power consumption of the photovoltaic system, an open-circuit voltage, and an operating voltage of the photovoltaic panel;
determining a first threshold based on the system minimum power consumption and the load minimum power consumption;
determining a second threshold based on the open-circuit voltage; and
determining a ratio threshold based on the open-circuit voltage and the operating voltage.

8. The method according to claim 2, wherein the adjusting is based on each of the first output voltage and the second output voltage being within a preset voltage range.

9. The method according to claim 4,
wherein before obtaining the first output voltage of the photovoltaic panel, the method further comprising:
obtaining an output voltage of the photovoltaic panel; and
verifying an operating status of the switching device based on that the output voltage meets preset operating conditions, or
wherein the controlling the photovoltaic panel to access the micro-inverter comprises: controlling the switching device to turn on.

10. The method according to claim 3, wherein the first power parameter is obtained by dividing a square of the second output voltage by the resistance.

11. A photovoltaic system comprising:
a load;
a micro-inverter connected to an electrical equipment;
a photovoltaic panel connected to the load and the micro-inverter;
a switching device connected to the load; and
a controller connected to the switching device, wherein the controller is configured to:
determine an output power parameter and an output electrical parameter
ratio associated with the photovoltaic panel; and
adjust a connection status between the photovoltaic panel and the micro-inverter based on the output power parameter and the output electrical parameter ratio.

12. The photovoltaic system according to claim 11, further comprising:
a voltage collector coupled to the photovoltaic panel and the controller.

13. The photovoltaic system according to claim 11, wherein the controller is configured to adjust a connection status by controlling the photovoltaic panel to access the micro-inverter.

14. The photovoltaic system according to claim 13, wherein the controller is further configured to:
obtain a first output voltage of the photovoltaic panel when the switching device is open;
obtain a second output voltage of the photovoltaic panel when the switching device is closed; and
determine the output power parameter and the output electrical parameter ratio based on the first output voltage, the second output voltage, and a resistance of the load.

15. The photovoltaic system according to claim 14, wherein the output power parameter comprises a first power parameter and a second power parameter, and the controller is further configured to:
determine the first power parameter based on the second output voltage and the resistance;
determine the second power parameter based on the first output voltage, the second output voltage, and the resistance; and
determine the output electrical parameter ratio based on a ratio of the second output voltage to the first output voltage.

16. The photovoltaic system according to claim 11, wherein the controller is further configured to:
obtain an output voltage of the photovoltaic panel; and
based on that the output voltage satisfies a threshold, control the switching device to be closed.

17. The photovoltaic system according to claim 15, wherein the first power parameter is obtained by dividing a square of the second output voltage by the resistance.

18. The photovoltaic system according to claim 11, wherein the controller is further configured to:
control the photovoltaic panel to access the micro-inverter based on the output power parameter and the output electrical parameter ratio satisfying preset parameter conditions.

19. A method for operating a photovoltaic system, comprising:
determining, by a controller,
a first output voltage of a photovoltaic panel when a switching device is open, wherein the photovoltaic panel is connected to a load and a micro-inverter, and the load is connected to a switching device,
a second output voltage of the photovoltaic panel when the switching device is closed, and
adjusting a connection status between the photovoltaic panel and the micro-inverter based on the first output voltage and second output voltage.

20. The method according to claim 19, wherein the adjusting comprises adjusting the connection status between the photovoltaic panel and the micro-inverter based on a ratio of the second output voltage to the first output voltage.
